(19) United States
(12) Patent Application Publication
(10) Pub. No.: US 2025/0223138 A1
(43) Pub. Date: Jul. 10, 2025

(54) WINCH AUTOMATION DEVICE, ASSOCIATED AUTOMATED WINCH AND ASSOCIATED INSTALLATION METHOD

(71) Applicant: EWINCHER, SAINT-GENIS-LES-OLLIERES (FR)

(72) Inventor: Bruno RABU, BORMES LES MIMOSAS (FR)

(21) Appl. No.: 18/853,262

(22) PCT Filed: Mar. 28, 2023
(86) PCT No.: PCT/FR2023/050445

§ 371 Date: Oct. 1, 2024

(30) Foreign Application Priority Data
Apr. 1, 2022 (FR) FR2203013

(51) Int. Cl. B66D 1/52; B63B 79/40; B63H 9/06; B66D 1/12; B66D 1/74

(52) U.S. Cl. CPC B66D 1/525; B63B 79/40; B63H 9/06; B66D 1/12; B66D 1/7463

(57) ABSTRACT

The invention relates to a winch automation device comprising:
a motor (12) intended to engage a capstan drum (2) of the winch;
a supervision member (15) of the motor able to fix the torque applied by the motor to the capstan drum (2);
a memory (22) integrating a set of pre-recorded manoeuvres (29, 32, 33), each manoeuvre being associated with at least one limit force (30, 31);
means (28) for measuring the force engaged on the winch; and
a human-machine interface (26a), connected to the supervision member, and comprising:
motor-actuation means (35-37);
manoeuvre selection means (34); and
at least one display (27) able to convey to a user of the winch information regarding the force engaged on the winch and information regarding the expected limit force for the selected manoeuvre.

### TECHNICAL FIELD

The present invention relates to the technical field of nautical equipment and, more specifically, to accessories used on sailboats. It relates more specifically to an automated or semi-automated winch, i.e. a winch in which at least one manoeuvre can be carried out through the intervention of a motor.

More specifically, the invention aims for winch automation device, an automated winch and a method for installing the automation device.

### PRIOR ART

Generally, a sailboat comprises one or more devices called “winches”, which are specific hoists, intended for controlling at least one sail of a boat, around which a string, also called rope, is wound and unwound, for example to border sheets or hoist a sail. A winch consists of a capstan drum on which the rope can be wound to carry out a manoeuvre. Generally, the capstan drum is rotated by a crank used by a user.

In a sailing manoeuvre on a sailboat (tacking, reefing, jibing, mainsail raising, genoa trim, mainsail trim, spinnaker hoisting, spinnaker trim, tautening of backstays, winding of a headsail, etc.), it is important to carry out the manoeuvre successfully, quickly, accurately and without breaking anything. Indeed, as long as the manoeuvre is not completed, the boat is in an unstable and uncomfortable transitional situation, and with sails that flog and become damaged. It is therefore sought to carry out the manoeuvre as quickly as possible to return to a perfectly stable situation without risk to the equipment.

To be as fast as possible, while having a force exerted on the crank which is compatible with human capacities and the traction force sought on the rigging, winches are generally equipped with two or three reduction speeds. These speeds make it possible to achieve the sought traction force on the rigging at the maximum speed possible for a sailor.

Whatever the manoeuvre, and particularly for tacking, reefing, and hoisting sails (mainsail, spinnaker, etc.), there are two different situations in which the forces engaged are not the same: the transitional phase, and the final phase.

During the transitional phase, the forces are “moderate”, the sailor will seek both to be fast by rotating their manual crank as quickly as possible on the most suitable speed of the winch to keep a moderate force, and they will be extremely vigilant. Indeed, during this transitional phase, if they feel a sensation of a sudden increase in force, they must stop and seek to understand what is happening, because it is often a sign of something getting stuck.

As an example, on a 40-foot sailboat and in a mainsail raising manoeuvre, when a sailor feels a haptic feedback which seems abnormal to them, typically a haptic feedback of between 8 and 13 kg by manoeuvring at high winch speed or between 5 and 8 kg at low winch speed, caution generally commands them to stop and control the equipment. If they continue the manoeuvre, there is a significant risk of breaking something.

However, the experience of the sailor is particularly important for determining when they must stop a manoeuvre to control the boat, as the feeling, the potential sources of problems and the forces engaged vary from one manoeuvre to another and from one boat to another.

Typically, for raising mainsails, the manoeuvre consists of hoisting the sail by deploying the mainsail, boat facing the wind, without breaking or tearing anything. In this manoeuvre, the sources of problems are multiple: slider which can get stuck, slat which can get caught in the holding rigging of the sailbag, reefing line not released, etc. If the sailor does not feel these different problems, the tension applied to the winch can generate a breakage or tearing of the sail.

For the tacking of the genoa, the manoeuvre consists of releasing the sheet downwind, followed by taking back the sheet on the other tack at the same time as the boat passes into the wind, the genoa then passes on the other tack and the sailor progressively borders the genoa. During this manoeuvre, several sources of problems are also possible: a sheet can make a knot at the entrance of the pulley of the traveler bar and get stuck, a sheet can get stuck on a mast step or other spar on the deck, etc. If something gets stuck and the sailor starts to pull hard on the sheet, equipment can break.

For the reefing, the manoeuvre consists of reducing the surface area of the mainsail, it is a manoeuvre which is done when wind conditions are strong, i.e. when there are significant forces on the boat, it is therefore necessary to be particularly vigilant. The transitional phase consists of reducing the mainsail. To do this, the sailor starts by aligning the mainsail with the wind, then they pick up the reefing line, while releasing the mainsail halyard. During this manoeuvre, the risk is particularly that a slider gets stuck, which can tear the mainsail. Thus, visually controlling and controlling forces engaged on the crank are very important for this manoeuvre. During this transitional phase of the manoeuvre, the forces engaged are limited and if something gets stuck, the sailor quickly feels resistance, which nevertheless remains of a much lower intensity than the torque they need to tauten the mainsail.

When hoisting a spinnaker, a situation of getting stuck can also occur, for example when the halyard loop gets stuck on a sheave, or the halyard gets caught in a spreader. Detecting abnormally high force is important to avoid breakage.

When a sailor winds a headsail, this is yet another level of force which is engaged. There are also dangerous situations of getting stuck for the equipment, and the sailor must feel both the forces engaged and the limits from which a risk of breaking the equipment is probable.

Moreover, further to the transitional phase, the forces also vary in the final adjustment phase. For example, for the raising of the mainsail, the reefing or the hoisting of a spinnaker, these manoeuvres end with the tautening of the halyard. The forces are thus very high, and there is almost no risk of breakage. In this final phase, the sailor mainly seeks to accurately adjust the tension level on the sail with the required force, often very high. For the tacking, the final phase consists of bordering to adjust the tension of the sail, the forces engaged are thus very high, although often lower than for the tautening of the mainsail in strong winds.

Thus, there are a large number of different manoeuvres with distinct phases during which a seasoned sailor must feel the forces engaged and the evolution of the tension on the rope. It is for this main reason, that the majority of winches are still manual winches.

Moreover, to limit forces and improve the winding speed of the rope around the capstan drum of the winch, it is also possible to use an automated or motor-assisted winch, i.e. a winch in which a motor drives the capstan drum. Indeed, automated winches were first introduced for tired sailors, for example through age, and for whom the forces to be engaged in manual manoeuvres are too difficult. Then, automated winches have been developed for the comfort of sailors and to enable the carrying out of manoeuvres quicker than with a manual winch.

There are now manual winches, automated winches, and motor-assisted winches. Document FR 3 055 619 describes, for example, the structure of motor-assisted winch of the prior art.

In manual or motor-assisted winches, the user feels a haptic feedback during the manoeuvre of the winch, which makes them feel the tension applied to the rope by the winch.

This feeling of the forces engaged on the rigging, thanks to the haptic feedback, is essential for avoiding risks linked to the manoeuvres stated above.

Thus, in terms of safety, as soon as the user feels a force which is too high with respect to the manoeuvre engaged, they can detect a problem and stop their manoeuvre before breaking something. Furthermore, this “feeling” is also very important in sailing, such that the user can correctly adjust their manoeuvre (halyard tension, backstay tension, etc.).

Automated winches, such as described in document WO 2008/027111, do not make it possible to convey this haptic feedback, and the risk of breakage during a manoeuvre is thus very high. On the contrary, automated winchs are very efficient, since they are capable of actuating the winch at a speed which is much greater than that of a manual or motor-assisted manoeuvre.

To manage variations in forces to be applied to an automated winch, document EP 2 179 959 proposes to detect the gear ratio used by the winch and to fix the torque applied by the electric motor coupled to the winch according to the detected gear ratio. However, this solution does not make it possible to be adapted to the great variability of manoeuvres which are able to be used with a winch.

For example, with the solution of document EP 2 179 959, it is possible to fix two distinct limits for a winch with a yield of 60%, having a first speed with a power ratio of 11 and a second speed with a power ratio of 46. For the first speed, it is possible to fix the limit at 25 kg, such that the maximum traction on the rope can reach 165 kg (25×11×0.6). For the second speed, it is possible to fix the limit at 20 kg, such that the maximum traction on the rope can reach 552 kg (20×46×0.6). These values are consistent to achieve a hoisting of the mainsail with the first speed and a tautening of the mainsail in second speed. However, for other manoeuvres, these limits may be too restrictive to carry out the manoeuvre at full speed; or too wide to limit the risk of breaking the equipment.

Thus, even with the solution described in the document EP 2 179 959, the major problem of automated winches resides in the risk of breaking the equipment when too much tension is applied to a rope or to a sail. Currently, with an automated winch, it is not rare to break equipment by using an automated winch or also to tear a sail.

In order to respond to this technical problem, it would be possible to use a torque limiting system imposed by the automated winch. However, torque limitation is, in practice, extremely complex to implement, since a winch is generally used for a large number of distinct manoeuvres and the torques implemented for these different manoeuvres are also very variable.

Thus, by sizing an automated winch with a low-power electric motor so as to prevent the winch from having the power necessary to break the equipment, the power of the winch could be insufficient for certain manoeuvres, in particular, during the final phases, and this power could however be sufficient to damage the equipment.

It must be noted that some hoists, as described in documents U.S. Pat. No. 9,975,742, US 2015/284229, US 2021/229963, US 2016/098096 or US 2016/046468, integrate a human-machine interface to indicate the forces engaged in lifting or pulling loads. However, these hoists are not adapted to the field of sailing, and therefore do not correspond to sailboat winches. Moreover, the single piece of information regarding the forces engaged by a winch would not be sufficient to respond to the technical problem, given the great variability of manoeuvres and the problems being able to occur on these manoeuvres.

The technical problem of the invention is therefore to find how to obtain an automated winch, making it possible for a crew member to actuate the winch without force, by correctly adjusting its manoeuvre, while protecting the equipment during different manoeuvres.

### SUMMARY OF THE INVENTION

In order to overcome this technical problem, the invention proposes to use a human-machine interface associated with a memory in which manoeuvres are pre-recorded with limiting forces associated with each manoeuvre. The human-machine interface makes it possible, on the one hand, for a user to select the manoeuvre that they seek to carry out and, on the other hand, to obtain information regarding the force engaged over time during the manoeuvre.

Thus, the user can obtain information regarding the force engaged and check, during the manoeuvre, that the force engaged is not disproportionate with respect to the limit force pre-recorded for the selected manoeuvre.

According to a first aspect, the invention relates to a winch automation device for controlling at least one sail of a boat, the winch comprising a capstan drum intended to receive a rope for carrying out a manoeuvre, said automation device comprising:
a motor intended to engage said capstan drum of the winch; and
a motor supervision member able to fix the torque applied by the motor to the capstan drum.

The invention is characterised in that the device also comprises:
a memory integrating a set of pre-recorded manoeuvres, at least one manoeuvre corresponding to a raising of the mainsail or the tautening of a halyard;
each manoeuvre being associated with at least one limit force;
means for measuring the force engaged to the winch; and
a human-machine interface, connected to the supervision member, comprising:
means for actuating the motor;
means for selecting a manoeuvre from among the set of pre-recorded manoeuvres; and
at least one display able to convey to a user of the winch, information regarding the force engaged on the winch and information regarding the expected limit force for the selected manoeuvre.

Thus, the invention relates to a winch automation device. This automation device can be installed during the construction of the boat at the same time as the winch installation. In a variant, this device can be added to an existing winch of a boat. In addition, the winch actuation motor can correspond to an electric motor or a hydraulic motor without changing the invention.

Furthermore, this device can provide the only means of actuating the winch, thus obtaining a fully automated winch. Mechanical means can also make it possible to uncouple the motor to enable a manual actuation of the winch, thus forming a semi-automated winch.

The invention therefore makes it possible to provide two crucial pieces of information to the user: the force engaged on the winch and the expected force limit for the selected manoeuvre.

These two pieces of information make it possible for the user to maintain control over the forces engaged, even during the transitional phases. As is the case with the haptic feedback felt by the user when a winch is manually actuated, this information conveyed by the human-machine interface makes it possible for the user to finely adjust their manoeuvre with great safety for the equipment.

Concerning the force engaged on the winch, it can be estimated or measured in several ways.

According to a first variant, the motor corresponding to an electric motor, the force engaged on the winch is estimated from the electrical power consumed by the motor.

In practice, the motor often corresponds to an electric motor powered by a fixed voltage while the motor supply current can vary. It is therefore possible to characterise the motor torque according to the intensity applied to the motor and to the rotation speed of the motor. By measuring the supply current of the motor, and by knowing the rotation speed of the motor, it is possible to determine, at any time, the torque exerted by the motor. Knowing the reduction ratio of the electric motor, also knowing the different reduction ratios of the motorised winch, as well as the yield of the winch, it is possible to calculate, at any time, the tension force exerted by the rope on the winch which is directly proportional to the motor torque.-Thus, when the winch comprises two directions of rotation associated with distinct reduction ratios, the force engaged according to the intensity differs according to the direction of rotation selected.

This first variant of obtaining the engaged force makes it possible to obtain information with an accuracy of around 10% with the force actually measured on the rope.

According to a second variant, the force engaged on the winch is measured from at least one strain gauge mounted between a movable element of the winch or the motor and a fixed element. For example, the movable element can correspond to an epicyclic gear train of the motor or a gear of the winch, while the fixed element may correspond to a casing of the motor. These strain gauges make it possible to obtain information regarding the traction undergone by the winch due to the tension of the rope, and therefore on the torque engaged on the rope.

Further to the method of obtaining the force engaged on the winch, this information can be displayed on the human-machine interface in several ways.

Indeed, the engaged force can be expressed in kilograms equivalent to a force exerted by a crank. The force engaged can also be expressed in rigging tension at the winch output.

To do this, it is necessary to accurately know the features of the winch, as the force in the rigging is not only according to the torque exerted by the motor on the winch drive shaft, but also according to the winch reduction ratio in the speed in question, and naturally also according to the yield of the winch.

Whatever the expression of the force engaged on the human-machine interface (kilograms equivalent to a force exerted by a crank or rigging tension at the winch output), the limit forces of each manoeuvre are displayed with the same expression.

These limit forces can be used only as information for the user, such that they can compare the force currently engaged on the winch with an expected force for the ongoing manoeuvre, or also for an adjustment (backstay tension, halyard tensions, etc.) by approaching what is usual to achieve with their traditional crank.

Preferably, the supervision member comprises a torque limiter configured to limit the torque of the motor when the force engaged on the winch reaches the limit force recorded for the selected manoeuvre.

Thus, even if the user does not monitor the human-machine interface to detect an exceeding of the limit force recorded for the selected manoeuvre, the supervision member can be configured to impose a torque limit on the winch for each manoeuvre.

Preferably, the human-machine interface integrates means for modifying the limit force for the selected manoeuvre. This modification of the limit force can be carried out during the manoeuvre to circumvent the limit imposed by the torque limiter.

Furthermore, this modification of the limit force can be recorded or not in the memory, such that it can be reused for a next manoeuvre of the same nature.

For each type of manoeuvre, the user can therefore record the force limits that they do not seek to exceed. These limits can be different for several winch speeds. Thus, by iteratively modifying the limits as they wish, the user can create a set of pre-recorded manoeuvres.

For example, a manoeuvre can correspond to the raising of the mainsail with a limit in a first speed at 19.7 kg of equivalent force on a crank, or 130 kg of tension on the rope, and a limit in a second speed at 4.7 kg of equivalent force on a crank, or also 130 kg of tension on the rope. Another manoeuvre can correspond to the tautening of a halyard with a limit in a first speed at 30 kg of equivalent force on a crank, or 198 kg of tension on the rope, and a limit in a second speed at 25 kg of equivalent force on a crank, or 690 kg of tension on the rope.

By recording the modifications of the limit forces in the memory, the user can thus modify their preferences over time, as they feel.

Furthermore, it is also possible to modify this value from an administration console. For example, the supervision member and/or the human-machine interface can integrate wireless communication means with a portable device on which an administration console makes it possible to adjust parameters of the human-machine interface and/or of the supervision member.

For example, from the human-machine interface or from the administration console, it is possible to modify the luminosity, the text size, the language of the human-machine interface, the winch parameters making it possible to obtain the forces engaged, the limit forces associated with the different manoeuvres recorded in the memory, to add new manoeuvres, etc.

Moreover, this device can be added to any type of winch by sizing the motor according to the features of the winch.

According to a second aspect, the invention relates to an automated winch comprising:
a capstan drum intended to receive a rope to carry out a manoeuvre; and
a winch automation device according to the first aspect of the invention.

Preferably, the motor of the winch automation device corresponds to an electric motor powered by a battery which is associated with it.

In current automated winches, the electric motor is conventionally powered by electrical energy coming from an electrical network integrated into the boat. However, to supply the power necessary to power the motor, it is often required to use an electrical network transporting a significant power. In fact, the service batteries of boats are conventionally 12 or 24 volts and, to power electric winch motors, it is required to use large cables, typically with a cross-section of 35 mm², to be able to route an intensity that can exceed 100 amperes.

Yet, the integration and routing of these electric power cables inside a boat poses a large number of installation constraints.

By using a battery to power the electric motor, it is not necessary to integrate electric power cables inside the boat and electric low-power cables can be sufficient to recharge the battery, outside of the phases of using the winch. To do this, the battery is preferably connected to a recharging circuit with a voltage of less than 40 volts and a current of less than 3 amperes.

Preferably, the motor corresponds to a brushless motor associated with a gear reducer.

A gear reducer can correspond to an epicyclic gear train followed by a possible angle drive device to facilitate the integration of the motor under the winch.

In conventional winch motorisations, the motors correspond to a DC motor associated with a reducer of the worm wheel type, the overall yield of these motors is around 30%. With this embodiment of the invention using a brushless motor associated with a gear reducer, the overall yield of the motor can be around 60%, thus limiting energy losses. Furthermore, to obtain the same force, the level of electric power necessary to power a brushless motor associated with a gear reducer can be lower than to power a DC motor associated with a reducer of the worm wheel type. Thus, for one same voltage, it is possible to limit the intensity for powering a brushless motor associated with a gear reducer.

For example, to obtain a mechanical power of around 500 watts, current motors require a current of 138 amperes and this embodiment makes it possible to use only 28 amperes. It ensues that it is possible to use a cable with a cross-section of 6 mm² between the battery and the motor instead of using a cable with a cross-section of 35 mm².

The human-machine interface can also display information regarding the battery charge level.

Thus, the human-machine interface comprises at least one screen to display the force engaged, at least one limit force associated with the selected manoeuvre, optionally a description of the selected manoeuvre, optionally the selected winch speed, optionally the battery charge level and optionally the next manoeuvre and the preceding manoeuvre, such that the user can easily change the selected manoeuvre. Indeed, to select the manoeuvre, the human-machine interface can integrate pushbuttons, making it possible to switch from one manoeuvre to another.

Further to the manoeuvre selection buttons, the human-machine interface can comprise two means for actuating the motor for each direction of rotation of the winch. Preferably, the actuation of the motor is conditioned by using a “deadman” type control requiring the user to press at least two buttons to control the operation of the motor, such that an unintentional pressing of a button does not cause the motor to start.

Furthermore, the human-machine interface can be wired or wirelessly connected with the supervision member.

According to a third aspect, the invention relates to a method for installing an automation device according to the first aspect of the invention, the method comprising the following steps:
installing the motor, the supervision member and the human-machine interface; defining the type of winch in an administration console;
downloading, from a server, the limit forces associated with the type of winch defined for different manoeuvres;
recording limit forces in the memory; and
configuring the human-machine interface according to the user's preferences.

### BRIEF DESCRIPTION OF THE DRAWINGS

The way in which to carry out the invention, as well as the advantages which arise from it, will emerge from the description of the embodiments below, made with reference to the accompanying figures, in which:

FIG. 1 is a schematic representation of an automated winch according to an embodiment of the invention;

FIG. 2 is a perspective view of the human-machine interface of an implementation of the automated winch of FIG. 1;

FIG. 3 is a partially schematic cross-sectional view of an implementation mode of the motor of the automated winch of FIG. 1;

FIG. 4 is a representation of a part of a database containing features of different winches;

FIG. 5 is a schematic, perspective representation of a human-machine interface according to another embodiment of the invention; and

FIG. 6 is a schematic, front representation of the human-machine interface of FIG. 5.

### DETAILED DESCRIPTION OF EMBODIMENTS

FIG. 1 illustrates an automated winch according to an embodiment of the invention. The winch comprises a base 1 fixed to a hull 0 of a boat and a capstan drum 2 which is rotatably movable about a main transmission shaft 3.

More specifically, the capstan drum 2 comprises an upper part 2.1 making it possible to hold a rope 6 during the winding of it around a central part 2.3 of the capstan drum 2. A pivot connection 2.2 is formed between the capstan drum 2 and the hull 1 such that the capstan drum 2 is rotatably movable.

In a manual winch, the rotational movement of the capstan drum 2 is exerted by a winch crank fixed in a housing 3.1. This housing 3.1 rotates two gear trains 4 and 5. These two gear trains make it possible to rotate the capstan drum 2 in the same direction of rotation, but with distinct speeds. Thus, the pinions 4.1 and 4.2 of the gear train 4 make it possible to reverse the direction of rotation applied to the main transmission shaft 3. When a movement is applied in a first direction of rotation on the main transmission shaft 3, only the epicyclic gear train 4 is implemented to drive the capstan drum 2 with a first speed. Conversely, when the main transmission shaft 3 is driven in the other direction of rotation, only the epicyclic gear train 5 is implemented with the pinions 5.1 and 5.2 which impose a reduction ratio making it possible to limit the speed of the capstan drum 2.

Thus, a conventional winch has a transmission shaft 3 making it possible to support two directions of rotation, so as to drive a capstan drum 2 with two distinct speeds and one same direction of rotation.

Naturally, all mechanical configurations can be considered without changing the invention.

Whatever the mechanical configuration of the winch used, the invention proposes to automate the winch by driving the main transmission shaft 3 through a motor 12, preferably an electric motor. To do this, the lower part 3.2 of the main transmission shaft 3 can be coupled to the rotor of the motor 12.

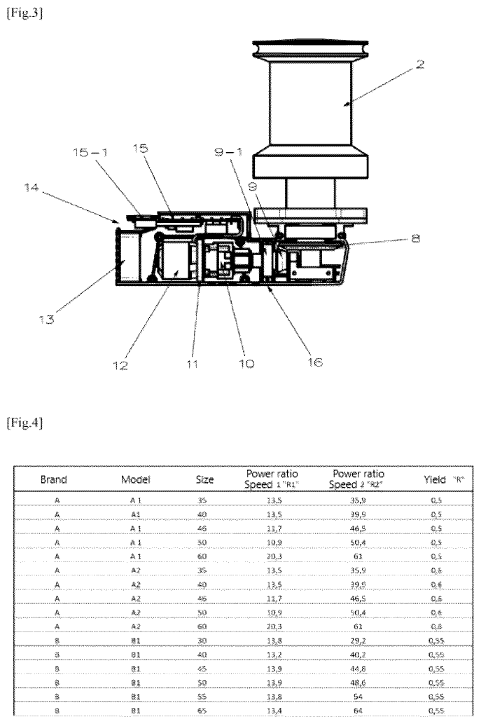

More specifically, as illustrated in FIG. 3, the rotor of the motor 12 can extend perpendicularly to the main transmission shaft 3, so as to limit the bulk of the automation device.

For example, the rotor of the motor 12 can be fixed to an epicyclic gear train 10, the output of which is connected to a pinion 9 supported by a bearing 9-1. A gear 8 then makes it possible to connect the pinion 9 to the main transmission shaft 3 of the winch. Preferably, a fan 13 is placed in the proximity of the motor 12 to ensure its cooling and the motor 12 is protected by a casing 16.

Further to the mechanical elements, the motor 12 can be electrically powered by a supervision member 15 integrated into the casing 16 of the motor 12. The supervision member 15 corresponds, for example, to a motherboard integrating a processor and a power control circuit 19 of the motor 12.

Such as illustrated in FIG. 3, this supervision member 15 can have connectors 15-1 which are accessible by opening a cover 14.

Preferably, the motor 12 corresponds to an electric motor and the motor 12 is powered by a battery 23 passing through the power control circuit 19 of the supervision member 15.

The battery 23 can be placed under the motor 12, itself placed under the winch, but it can also be movable according to the implementation constraints and disposed in any location of the boat. Thus, the power supply of the motor 12 can be provided directly by the battery 23 without having to route a significant electric power along the hull 0 of the boat.

Outside the phases of using the battery 23 to power the motor 12, a recharging circuit 25 can be implemented by the supervision member 15 by recovering the energy available on a low-voltage network 25, typically a network 25 with a voltage of less than 40 volts and a current of less than 3 amperes.

This network 25 can correspond to a cable which routes the energy from the service batteries of the boat, typically in 12 or 24 volts.

The supervision member 15 can be powered only by the battery 23 or by the battery 23 and the recharging circuit 25.

Furthermore, the supervision member 15 can integrate wireless reception means 21 in order to communicate with a portable device 38, such as a smartphone or a touchpad.

Moreover, the supervision member 15 is connected with the human-machine interface 26a. The connection between the human-machine interface 26a and the supervision member 15 can be made by wired or wireless means, for example by using wireless communication means 21.

The human-machine interface makes it possible for the user to select the manoeuvre that they seek to perform and to control the motor 12 in the first or the second speed.

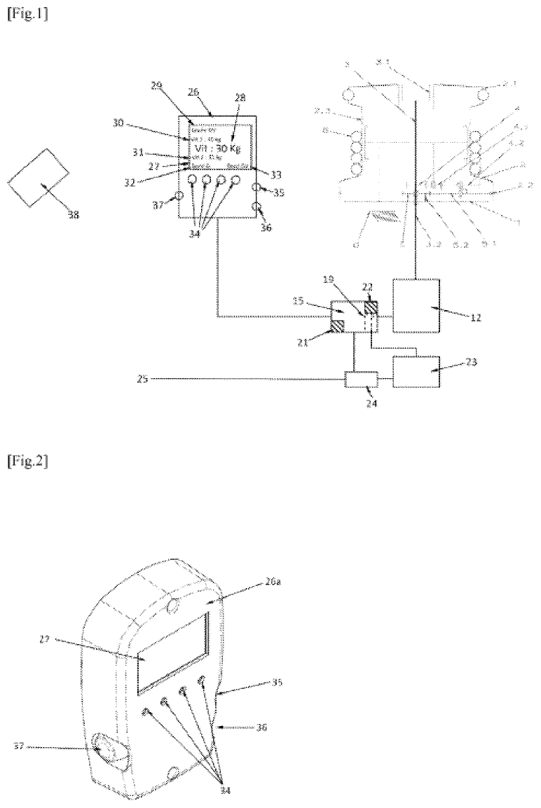

To control the starting of the motor 12 from the human-machine interface 26a, the user can press a button 35 for activating the motor 12 in the first speed or a button 36 for activating the motor 12 in the second speed. An example of a human-machine interface 26a is illustrated in FIG. 2.

Furthermore, to guarantee the safety of the automation device, the user must preferably press one of the buttons 35 or 36 and a second button 37 simultaneously to ensure that the user actuates at least two buttons simultaneously when they seek to start the rotation of the winch.

The buttons 35 and 36 can correspond to pushbuttons, while the button 37 can correspond to a potentiometer making it possible to adjust the rotation speed according to the pressure force on the button 37.

According to the invention, when the user actuates the winch, they receive, on the human-machine interface 26a, information regarding the force 28 engaged on the winch. This force 28 engaged on the winch can be measured by strain gauges or estimated from the electrical power conveyed to the motor 12.

To display the engaged force 28, the human-machine interface 26a has a display 27, for example a screen, on which the engaged force 28 is displayed and updated in real time, for example every tenth of a second. Further to the engaged force 28, the screen 27 can also display information regarding the expected limit force 30, 31 for the selected manoeuvre 29. In the example of FIG. 1, the screen 27 displays the expected limits 30, 31 for the two rotation speeds of the winch. In a variant, one single limit force can be displayed by detecting the direction of rotation selected by the user.

Further to this information on the engaged force 28 and the limit force 30, 31, the selected manoeuvre 29 can also be displayed on the screen 27, such that the user can confirm that they have selected the sought correct manoeuvre.

To select the manoeuvre to be carried out, the human-machine interface 26a preferably has manoeuvre selection buttons 34. For example, if the winch is configured to carry out four manoeuvres, the human-machine interface 26a can comprise four buttons 34 to select one of the four manoeuvres. In a variant, five buttons 34 can be used.

In practice, the number of manoeuvres is often very high, and it is preferable to use the human-machine interface 26a to make it possible for the user to select the sought manoeuvre 29 by scrolling through the pre-recorded manoeuvres. Thus, on the human-machine interface 26a, the screen 27 can also display the preceding manoeuvre 32 and the next manoeuvre 33, thus facilitating the scrolling of the different manoeuvres proposed, such that the user can select the sought manoeuvre.

The manoeuvre selection buttons 34 can also be used to configure some of the information of the human-machine interface 26a or the limit forces 30, 31. For example, from the four buttons 34, two buttons can be used to select the sought manoeuvre and two other buttons can be used to raise or lower the expected limit for the current manoeuvre and the speed currently used. Thus, the user can optionally modify the pre-recorded values of the limit forces 30, 31 in order to adapt to their feeling for the manoeuvre carried out. Naturally, many other parameters can be modified through the human-machine interface 26a, such as luminosity, language or also text size.

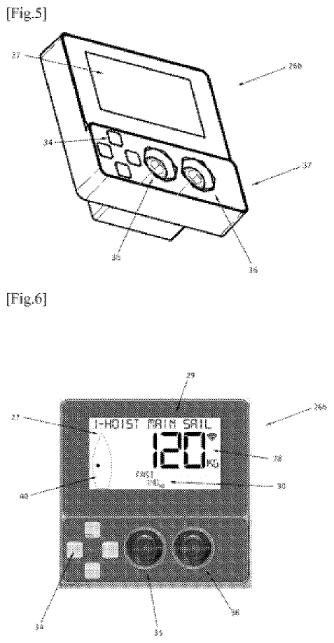

FIGS. 5 and 6 illustrate another example of a human-machine interface 26b in which the buttons 35 and 36 correspond to potentiometers, making it possible to adjust the rotation speed, while the button 37, which cannot be seen, corresponds to a pushbutton. The four buttons 34 are disposed in the form of a cross, and also make it possible to select the manoeuvre, and to optionally adjust the limit.

On the screen 27, the selected manoeuvre is displayed at the top, while the engaged force 28 is disposed at the centre and to the right of the screen 27. At the centre and at the bottom of the screen 27, the limit force 30 is displayed with the speed 41 currently implemented by the user, by selecting one of the buttons 35 or 36. Moreover, to the left of the screen 27, the sailboat 40 is schematised with a black dot corresponding to the position of the controlled winch, so that the human-machine interface 26b can be used for several motorised winches of the sailboat 40. If the user exceeds the indicated limit force 30, the engaged force 28 can be displayed in red or surrounded by a flashing red square to quickly inform the user.

Moreover, the human-machine interface 26b can be used to control other electrical systems of the sailboat and the representation of the sailboat 40 thus makes it possible to indicate which electric systems are controlled or configured by the user.

Moreover, other parameters can be fixed from an administration console running on the portable device 38. For example, this administration console can come from a mobile app for a smartphone or touchpad that the user can download from an app store.

This administration console is particularly useful when the user seeks to install the automation device on an existing winch, as they can then get information regarding the features of the winch and use the administration console to connect to a server on which limit forces are pre-recorded for different types of winch, such as illustrated in FIG. 4. By downloading the limit forces 30, 31 for different manoeuvres and for the specific winch, these limit forces 30, 31 can be recorded in a memory 22 of the supervision member 15. In a variant, the memory 22 can be disposed in the human-machine interface 26a-26b.

The human-machine interface 26a-26b is configured to display the limit forces 30, 31 of the manoeuvres pre-recorded in this memory 22 or simply to inform the user when a limit force is reached or practically reached. Moreover, this administration console can prove to be particularly useful for analysing usage data (history, operating time, forces engaged by manoeuvre type, etc.).

An example of information stored on the remote server is illustrated in FIG. 4 with different winch brands, different winch types and different sizes.

From these features of the winch, it is possible to obtain the reduction ratios and the yield of the winch making it possible to estimate, from the electric power consumed by the motor 12, the force 28 engaged on the winch.

With the obtaining of the force 28 engaged on the winch and the expected limit force 30, 31 for the selected manoeuvre 29, the user can now use a winch effortlessly, while benefiting from feedback for this manoeuvre. By regularly monitoring this information available on the human-machine interface 26a-26b, the user can therefore limit the risk of breaking the equipment during the different manoeuvres, while benefiting from very quick manoeuvres to limit the transitional phases.

Moreover, if the user seeks to limit the attention that they must pay to the human-machine interface 26a-26b during manoeuvres, the automation device can also comprise a torque limiter configured to limit the torque of the motor 12 when the engaged force 28 reaches the expected limit force 30, 31 for the speed and the selected manoeuvre 29.

Thus, the invention proposes to provide new information associated with a winch to facilitate controlling the winch in the different possible manoeuvres of a boat, while benefiting from quick manoeuvres and while limiting the risk of breaking the equipment or tearing the sails.

1. A winch automation device for controlling at least one sail of a boat, the winch comprising a capstan drum intended to receive a rope for carrying out a manoeuvre, said automation device comprising:
a motor intended to engage said capstan drum of the winch; and
a supervision member of the motor able to fix the torque applied by the motor to the capstan drum;
wherein the device also comprises:
a memory integrating a set of pre-recorded manoeuvres, at least one manoeuvre corresponding to a raising of the mainsail or the tautening of a halyard;
each manoeuvre being associated with at least one limit force;
means for measuring the force engaged on the winch; and
a human-machine interface, connected to the supervision member, comprising:
means for actuating the motor;
means for selecting a manoeuvre from among the set of pre-recorded manoeuvres; and
at least one display able to convey to a user of the winch, information regarding the force engaged on the winch and information regarding the expected limit force for the selected manoeuvre.

2. The winch automation device according to claim 1, wherein, the motor corresponding to an electric motor, the force engaged on the winch is estimated from the electric power consumed by the motor.

3. The winch automation device according to claim 1, wherein the force engaged on the winch is measured from at least one strain gauge mounted between a movable element of the winch or of the motor and a fixed element.

4. The winch automation device according to claim 1, wherein the supervision member comprises a torque limiter configured to limit the torque of the motor when the force engaged on the winch reaches the limit force recorded for the selected manoeuvre.

5. The winch automation device according to claim 1, wherein the human-machine interface integrates means for modifying the limit force for the selected manoeuvre.

6. The winch automation device according to claim 1, wherein the supervision member and/or the human-machine interface integrates wireless communication means with a portable device on which an administration console makes it possible to adjust parameters of the human-machine interface and/or of the supervision member.

7. The winch automation device according to claim 1, wherein the motor corresponds to a brushless motor associated with a gear reducer.

8. An automated winch comprising:
a capstan drum intended to receive a rope for carrying out a manoeuvre; and
the winch automation device according to claim 1.

9. The automated winch according to claim 8, wherein the motor of the winch automation device corresponds to an electric motor powered by a battery which is associated with it.

10. The automated winch according to claim 9, wherein the battery is connected to a recharging circuit with a voltage of less than 40 volts and a current of less than 3 amperes.

11. A method for installing the winch automation device according to claim 1, the method comprising the following steps:
installing the motor, the supervision member and the human-machine interface;
defining the type of winch in an administration console;
downloading, from a server, the limit forces associated with the type of winch defined for different manoeuvres;
recording the limit forces in the memory; and
configuring the human-machine interface according to the user's preferences.
